(19) United States
(12) Patent Application Publication
(10) Pub. No.: US 2012/0048739 A1
(43) Pub. Date: Mar. 1, 2012

(54) DOPING APPARATUS FOR MANUFACTURING ELECTRODE OF ENERGY STORAGE DEVICE, AND METHOD FOR MANUFACTURING ELECTRODE USING THE SAME

(75) Inventors: Dong Hyeok CHOI, Gyeonggi-do (KR); Bae Kyun Kim, Gyeonggi-do (KR); Hak Kwan Kim, Gyeonggi-do (KR); Ho Jin Yun, Gyeonggi-do (KR); Hong Seok Min, Gyeonggi-do (KR)

(73) Assignee: SAMSUNG Electro-Mechanics Co., Ltd.

(21) Appl. No.: 13/219,106

(22) Filed: Aug. 26, 2011

(30) Foreign Application Priority Data
Aug. 27, 2010 (KR) 10-2010-0083382

(51) Int. Cl. H01M 4/04; H01M 4/02

(52) U.S. Cl. 205/59; 204/275.1; 204/274

(57) ABSTRACT

Disclosed herein is a doping apparatus for manufacturing an electrode of an energy storage device of the present invention. The doping apparatus according to the exemplary embodiment of the present invention includes a doping chamber body providing a inner space in which a process doping an electrode plate with lithium ion is performed; and a plurality of doping rollers provided in the doping chamber body and containing lithium, wherein the doping rollers wind and feed the electrode plate within the doping chamber body.

### CROSS REFERENCE TO RELATED APPLICATION

This application claims the benefit of Korean Patent Application No. 10-2010-0083382, filed on Aug. 27, 2010, entitled “Doping Apparatus For Manufacturing Electrode Of Energy Storage Device, And Method For Manufacturing Electrode Using The Same”, which is hereby incorporated by reference in its entirety into this application.

### BACKGROUND OF THE INVENTION

1. Technical Field

The present invention relates to a doping apparatus for manufacturing an electrode of an energy storage device and a method for manufacturing an electrode using the same, and more particularly, a doping apparatus doping lithium ion on an electrode plate for manufacturing a negative electrode in order to manufacture a negative electrode of a lithium ion capacitor (LIC) and a method for manufacturing an electrode of a lithium ion capacitor using the same.

2. Description of the Related Art

A device called an ultracapacitor or a supercapacitor which is one of the next-generation energy storage devices, has been in the limelight as a next-generation energy storage device due to a rapid charging and discharging rate, high stability, and environmentally-friend characteristics. A general supercapacitor is configured to include an electrode structure, a separator, and an electrolyte solution, etc. The supercapacitor is in principle driven according to an electrochemical response mechanism that applies power to the electrode structure to selectively absorb carrier ions in the electrode.

At the present time, there is a lithium ion capacitor (LIC) as a representative supercapacitor. The general lithium ion capacitor has an electrode structure that includes a positive electrode composed of an active carbon and a negative electrode composed of various kinds of carbon materials (for example, graphite, soft carbon, and hard carbon), etc. The process for manufacturing a lithium ion capacitor includes an electrode manufacturing process forming an electrode structure by repeatedly stacking a positive electrode, a separator, and an negative electrode in sequence, a terminal welding process welding positive and negative terminals to the electrode structure, a lithium ion doping process previously doping the negative electrode with lithium ion (Li+), etc.

The representative lithium doping process according to the related art prepares a doping bath filled with the electrolyte solution and disposes the electrolyte structure and a lithium containing doping plate disposed to be opposite to the electrode structure in the doping bath. The negative electrode is doped with the lithium ion in the doping plate by repeatedly performing a charging process of applying voltage to the positive electrode and the negative electrode and a discharging process of applying voltage to the positive electrode and a lithium metal plate several times. However, the above-mentioned lithium doping process requires approximately 10 days or more in order to uniformly dope lithium ion throughout the negative electrode. The long lithium doping process is a main factor of degrading the production efficiency of the general lithium ion capacitor.

### SUMMARY OF THE INVENTION

An object of the present invention is to provide a doping apparatus efficiently doping an electrode of a lithium ion capacitor with lithium ion.

Another object of the present invention is to provide a lithium doping apparatus shortening a doping process time doping an electrode of a lithium ion capacitor with lithium ion.

According to an exemplary embodiment of the present invention, there is provided a doping apparatus for manufacturing an electrode of an energy storage device, including: a doping chamber body providing a inner space in which a process doping an electrode plate with lithium ion is performed; and a plurality of doping rollers provided in the doping chamber body and containing lithium, wherein the doping rollers wind and feed the electrode plate within the doping chamber body.

The doping rollers may include: first doping rollers contacting one surface of the doping plate; and second doping rollers contacting the other surface of the doping plate.

The doping apparatus for manufacturing an electrode of an energy storage device may further include a driver moving the doping rollers, wherein the driver moves the first doping rollers in a first direction to face the electrode plate and moves the second doping rollers in a direction opposite to the first direction to face the electrode plate.

The doping rollers may be disposed at both sides based on a straight line crossing the doping chamber body and the doping rollers disposed at one side of the straight line may be disposed to have a zigzag structure with the doping rollers disposed at the other side of the straight line based on the straight line.

The doping apparatus for manufacturing an electrode of an energy storage device may further include an electrode plate feeder feeding the electrode plate, wherein the electrode plate feeder includes: a first roller winding and standing-by the electrode plate prior to the lithium doping process; a second roller winding and recovering the electrode plate subjected to the lithium doping process and carried out of the doping chamber body; and third rollers guiding the electrode plate unwound from the first roller into the doping rollers and then, recovering the electrode plate fed by the doping rollers to the second roller.

The doping apparatus for manufacturing an electrode of an energy storage device may further include a heater heating the electrolyte solution so as to allow a temperature of an electrolyte solution to meet a temperature range of 20° C. to 70° C.

The doping chamber may further include an electrolyte solution filling an inner space, and the electrolyte solution includes at least one lithium-based electrolytic salt of LiPF6, LiBF4, LiSbF6, LiAsF5, LiClO4, LiN, CF3SO3, LiN(SO2CF3)2, LiN(SO2C2F5)2, LiC (SO2CF3) 2, LiPF4 (CF3) 2, LiPF3 (C2F5)3, LiPF3(CF3)3, LiPF5(iso-C3F7)3, LiPF5(iso-C3F7), (CF2)2(SO2)2NLi, and (CF2)3(SO2)2NLi.

The doping apparatus for manufacturing an electrode of an energy storage device may further include a dry chamber drying the electrode plate.

The dry chamber may include: a dry chamber body; fourth rollers disposed to have a zigzag structure in the dry chamber body; and a heater heating the electrode plate moved by the fourth rollers.

According to another exemplary embodiment of the present invention, there is provided a method for manufacturing an electrode of an energy storage device, including: standing-by an electrode plate; doping the electrode plate with lithium ion while feeding the electrode plate, by using doping rollers containing lithium ion; and recovering the electrode plate, wherein the standing-by the electrode plate, the doping the electrode plate with the lithium ion, and the recovering the electrode plate are performed in an in-situ manner.

The standing-by the electrode plate may include preparing a first roller to which the electrode plate is wound prior to performing the lithium doping process, and the recovering the electrode plate includes winding and recovering the electrode plate to a second roller after performing the lithium doping process.

The doping the electrode plate with lithium ion may include: preparing a doping chamber body filled with an electrolyte solution; disposing the doping rollers in the doping chamber body; and feeding the electrode plate by rotating the doping rollers in the state where the electrode plate contacts the doping rollers.

The doping the electrode plate with the lithium ion may include: preparing first doping rollers contacting one surface of the electrode plate; preparing second doping rollers contacting the other surface of the electrode plate; and alternately and repeatedly contacting the first doping rollers and the second doping rollers to one surface and the other surface of the electrode plate.

The doping the electrode plate with lithium ion may include: doping one surface of the electrode plate with lithium ion; and doping the other surface of the electrode plate with lithium ion, wherein the doping the one surface of the electrode plate with lithium ion and the doping the other surface of the electrode plate with lithium ion are alternately and repeatedly performed.

The doping the electrode plate with lithium ion may include heating the electrolyte solution so as to allow a temperature of en electrolyte to meet a temperature range of 20° C. to 70° C.

The electrolyte solution may include at least one lithium-based electrolytic salt of LiPF6, LiBF4, LiSbF6, LiAsF5, LiClO4, LiN, CF3SO3, LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi.

The method for manufacturing an electrode of an energy storage device may further include drying the electrode plate after performing the lithium doping process.

The method for manufacturing an electrode of an energy storage device may further include closely attaching the doping rollers to the electrode plate.

### BRIEF DESCRIPTION OF THE DRAWINGS

FIG. 1 is a diagram showing a lithium doping apparatus according to an exemplary embodiment of the present invention;

FIG. 2 is a flow chart for explaining a method for manufacturing an electrode using a doping apparatus according to the exemplary embodiment of the present invention; and

FIGS. 3 to 5 are drawings for explaining a process of manufacturing an electrode according to the exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Like reference numerals in the drawings denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a lithium doping apparatus according to exemplary embodiments of the present invention will be described in detail with reference to the accompanying drawings.

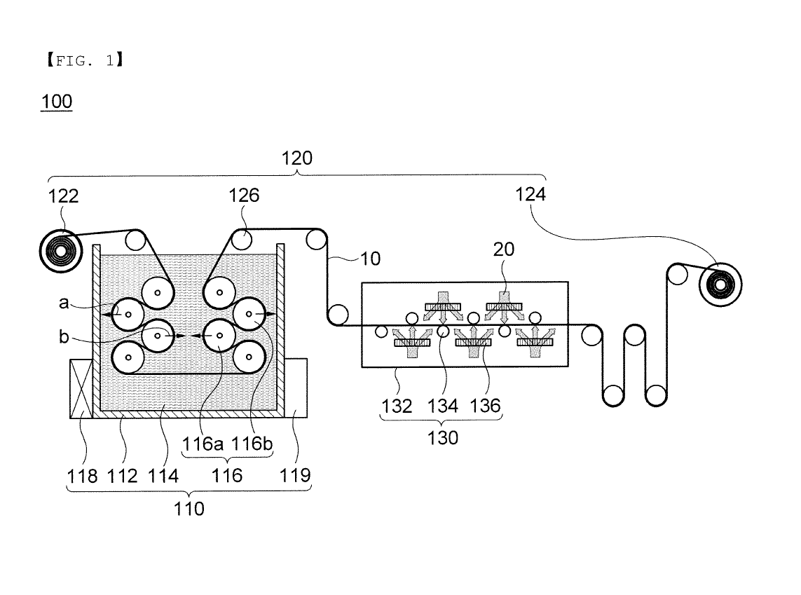

FIG. 1 is a diagram showing a lithium doping apparatus according to an exemplary embodiment of the present invention. Referring to FIG. 1, a lithium doping apparatus 100 according to an exemplary embodiment of the present invention may include a doping chamber 110, an electrode plate feeder 120, a dry chamber 130.

The doping chamber 110 may provide a process space in which the lithium pre-doping process doping the electrode plate 10 with lithium ion Li⁺ is performed. Herein, the electrode plate 10 may be a metal plate for manufacturing an electrode of an energy storage device called an ultracapacitor or a supercapacitor. As an example, the electrode plate 10 may be a metal plate for manufacturing a negative electrode of a lithium ion capacitor (LIC).

The doping chamber 110 may include a doping chamber body 112, a doping roller 116, a temperature controller 118, and an electrolyte solution circulator 119.

The doping chamber body 112 may have an inner space performing a process doping the electrode plate 10 with lithium ion. The doping chamber body 112 may be used as a support for supporting components of the doping apparatus 100. The doping chamber body 112 may be provided with openings (not shown) for entering the electrode plate 10.

The inner space of the doping chamber body 112 may be filled with a predetermined electrolyte solution 114. The electrolyte solution 114 may be composition prepared by dissolving an electrolytic salt including the lithium ion (Li⁺) in a predetermined solvent. As the electrolytic salt, a lithium-based electrolytic salt may be used. The lithium-based electrolytic salt may include at least any one of LiPF6, LiBF4, LiSbF6, LiAsF5, LiClO4, LiN, CF3SO3, and LiC. Alternatively, the lithium-based electrolyte salt may include at least any one of LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi. The above-mentioned electrolytic solution 114 may use a medium moving the lithium ion from the doping roller 116 to the electrode plate 10.

The doping roller 116 may be a roller doping the electrode plate 10 with the lithium ion. To this end, the doping roller 116 may be a roller including the lithium ion. As an example, the doping roller 116 itself may be a roller composed of lithium. As another example, the doping roller 116 may be a predetermined plate or film composed of lithium provided on the surface thereof and may be a film-coated roller. The doping roller 116 may be disposed in plural. When the doping roller 116 is provided in plural, the doping rollers 116 may be configured to directly contact the electrode plate 10 in the doping chamber body 112 and guide the movement of the electrode plate 10. For example, the doping rollers 116 may include a first doping roller 116a contacting one surface of the electrode plate 10 and a second doping roller 116b contacting the other surface of the electrode plate 10. The first doping roller 116a and the second doping roller 116b may be configured to be alternately disposed along the moving path of the electrode plate 10. In addition, the first doping roller 116a and the second doping roller 116b may substantially be disposed to form a zigzag structure. Therefore, one surface of the electrode plate 10 may be subjected to the doping process of the lithium ion by the first doping roller 116a and the other surface thereof may be subjected to the doping process of the lithium ion by the second doping roller 116b. In this case, the doping process on one surface of the electrode plate 10 and the doping process of the other surface of the electrode plate 10 may be alternately and repeatedly performed.

Further, the doping rollers 116 may feed the electrode plate 10 so as to move the electrode plate 10 in the doping chamber 110 while closely attaching the electrode plate 10 to the doping rollers 116. In other words, the doping rollers 116 may feed the electrode plate 10 so as to move the electrode plate 10 in the doping chamber 110 while applying the electrode plate 10 to the doping rollers 116 at a predetermined pressure. To this end, the doping rollers 116 may pressure the electrode plate 10 so as to keep the electrode plate 10 tight. As an example, in the doping rollers 116, the first doping roller 116a and the second doping roller 116b may each be moved in different directions to push the electrode plate 10 at the time of the lithium doping process. In detail, the first doping roller 116a may be configured to be moved in a first direction (a) and the second doping roller 116b may be configured to be moved in a second direction (b) opposite to the first direction (a). To this end, the doping apparatus 100 may include a predetermined driver (not shown) for moving each of the doping rollers 116 in the first direction (a) or the second direction (b). As another example, the doping rollers 116 may be configured to pressurize the doping rollers 116 while the electrode plate 10 is fed by the doping rollers 116, without having the above-mentioned driver.

The temperature controller 118 may control the temperature of the electrolyte solution 114 in the doping chamber body 112. The temperature controller 118 may include at least one heater. The temperature controller 118 may heat the doping chamber 110 so that the temperature of the electrolyte solution 114 meets the temperature range of approximately 20° C. to 70° C. The temperature controller 118 may use at least one heater. The heater may be provided at various positions of the doping chamber body 112 but is not limited to one shown in FIG. 1.

The electrolyte solution circulator 119 may circulate the electrolyte solution 114 in the doping chamber body 112. There are various methods of circulating the electrolyte solution 114 by the electrolyte solution circulator 119. As an example, the electrolyte solution circulator 119 may be configured to include an electrolyte solution circulating line and a pump connected thereto so that it is connected to the doping chamber body 112 to supply and discharge the electrolyte solution 114. In addition, the electrolyte solution circulator 119 may further include an agitator included in the doping chamber body 112.

The electrode plate feeder 120 may feed the electrode plate 10 so that the electrode plate 10 is carried into the doping chamber 110 to be subjected to the doping process of the lithium ion by the doping roller 116 and then, carried out of the doping chamber 110. In addition, the electrode plate feeder 120 may feed the electrode plate 10 so that the doped electrode plate 10 passes through the dry chamber 130. For example, the electrode plate feeder 120 may have a roller structure including a plurality of rollers. As an example, the electrode plate feeder 120 may include a first roller 122, a second roller 124, and a third roller 126.

The first roller 122 may be a roller standing-by the electrode plate 10 before the doping process is performed. To this end, the first roller 122 may be included in the doping apparatus 100 in the state where the electrode plate 10 is wound thereto prior to the doping. On the other hand, the second roller 124 may be a roller recovering the electrode plate 10 subjected to the doping process. Therefore, the first roller 122 is a roller unwinding the electrode plate 10 and the second roller 124 may be a roller winding and recovering the electrode plate 10 that unwinds from the first roller 122.

The third roller 126 may be a roller guiding the movement of the electrode plate 10 so that the electrode plate 10 unwinding from the first roller 122 is subjected to the doping process while contacting the doping rollers 116 in the doping chamber 110 and is then recovered to the second roller 124. In addition, the third roller 126 may guide the movement of the electrode plate 10 so that the electrode plate 10 carried out of the doping chamber 110 passes through the dry chamber 130 and is then recovered to the second roller 124.

The dry chamber 130 may dry the electrode plate 10 subjected to the doping process. For example, the dry chamber 130 may include a dry chamber body 132, a fourth roller 134, and a heater 136. The dry chamber body 132 may have an inner space performing a dry process drying the electrode plate 10. The fourth roller 134 may be provided in order to increase the moving path of the electrode plate 10 in the dry chamber body 132. To this end, the fourth roller 134 may be disposed to form the zigzag structure at different heights in the dry chamber body 132. The heater 136 may heat the electrode plate 10 moved by the roller 134 in the dry chamber body 132. As the heater 136, a heater or a hot air blower may be used.

As described above, the lithium doping apparatus 100 according to the exemplary embodiment of the present invention includes the doping chamber 110 including the doping rollers 116 including lithium so that the electrode plate 10 may be doped with lithium ion while the electrode plate 10 is moved in the doping chamber 110 by the doping rollers 116. Therefore, the lithium doping apparatus according to the present invention directly contacts the doping rollers 116 while the electrode plate 10 is fed in order to perform the lithium doping process, thereby making it possible to improve the efficiency in the lithium doping process.

In addition, the lithium doping apparatus 100 according to the exemplary embodiment of the present invention may automatically and consecutively process the stand-by process of the electrode plate 10 prior to the doping, the doping process, the dry process, and the recovery process. Therefore, the lithium doping apparatus according to the present invention automates the lithium doping process in an in-line manner, thereby making it possible to improve the efficiency in the lithium doping process and shorten the lithium doping process time.

In addition, the electrode manufacturing process using the doping apparatus for manufacturing an electrode of an energy storage device according to the exemplary embodiment of the present invention will be described in detail. Herein, the overlapped description of the doping apparatus 100 described with reference to FIG. 1 may be omitted or simplified.

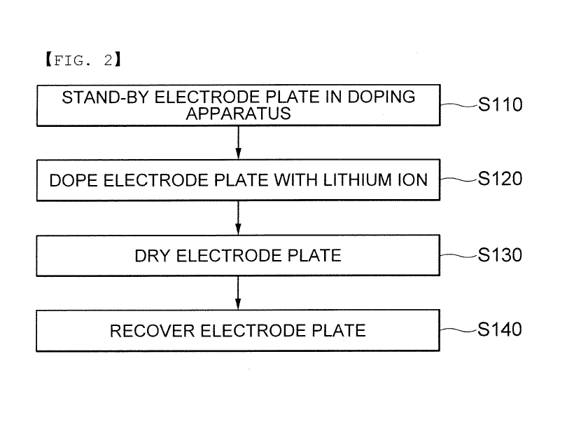

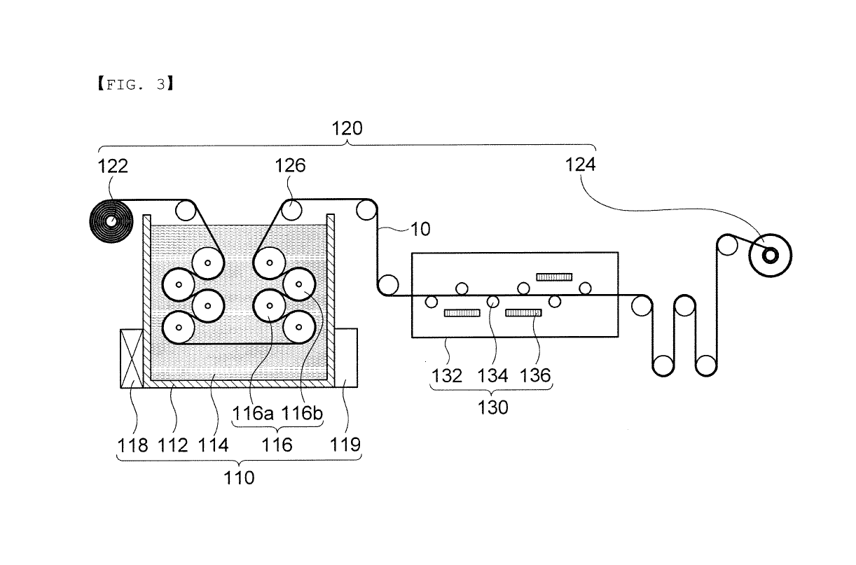

FIG. 2 is a flow chart for explaining a method for manufacturing an electrode using a doping apparatus according to the exemplary embodiment of the present invention and FIGS. 3 to 5 are drawings for explaining a process of manufacturing an electrode according to the exemplary embodiment of the present invention.

The method for manufacturing an electrode of an energy storage device according to the exemplary embodiment of the present invention may be made by consecutively processing the steps of standing-by an electrode plate, doping the electrode plate with lithium ion, drying the electrode plate, and recovering the electrode plate in an in-situ manner, by using the doping apparatus 100 described with reference to FIG. 1 Therefore, the method for manufacturing an electrode according to the present invention may automatically process the electrode plate standing-by process, the lithium ion doping process, the electrode plate drying process, and the electrode plate recovering process in an in-line manner.

Hereinafter, each of the electrode plate standing-by process, the lithium ion doping process, the electrode plate drying process, and the electrode plate recovering process will be described in detail.

Referring to FIGS. 2 and 3, the electrode plate 10 may stand-by in the doping apparatus 100 (S110). The standing-by the electrode plate 10 may include preparing the electrode plate 10 manufactured in a foil form, winding and storing the electrode plate 10 to the first roller 122, and mounting the first roller 122 wound to the electrode plate 10 on the doping apparatus 100.

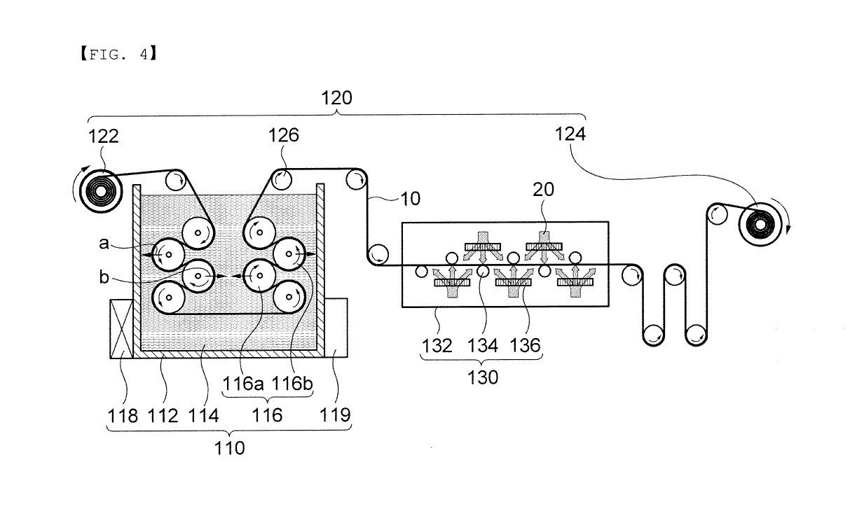

Referring to FIGS. 2 and 4, the electrode plate 10 may be doped with the lithium ion (S120). The doping the electrode plate 10 with the lithium ion may include preparing the doping chamber body 112 filled with the electrolyte solution 114, disposing the stacked structure of the doping rollers 116 including the lithium ion in the doping chamber body 112, and doping the doping rollers 116 with the lithium ion while contacting the doping rollers 116 and feeding therewith in the state where the electrode plate 10 is dipped in the electrolyte solution 114. In this case, one surface of the electrode plate may contact the first doping rollers 116a of the doping rollers 116 and the other surface of the electrode plate 10 may contact the second doping rollers 116b of the doping rollers 116. Therefore, both sides of the electrode plate 10 are alternately doped with the lithium ion, thereby making it possible to increase the efficiency in the doping process for the electrode plate 10. Herein, the feeding the electrode plate 10 may be made by driving the roller structure configured of the first to third rollers 122, 124, and 126.

Meanwhile, during the doping the electrode plate 10 with the lithium ion, the process temperature of the electrolyte solution 114 may be controlled to meet the temperature range of approximately 20° C. to 70° C. To this end, the temperature controller 118 may continuously heat the electrolyte solution 114 so that the temperature of the electrolyte solution 114 meets the process temperature. In addition, the electrolyte solution circulator 119 may circulate the electrolyte solution 114 in the doping chamber body 112.

In addition, during the doping the electrode plate 10 with the lithium ion, a step of closely attaching the doping rollers 116 to the electrode plate 10 may be further provided. As the doping rollers 116 may be closely attached to the electrode plate 10, the doping efficiency of the lithium ion for the electrode plate 10 may be increased. To this end, the first doping roller 116a may be moved in the first direction (a) and the second doping roller 116b may be substantially moved in the second direction (b) opposite to the first direction (a). Therefore, the doping of the lithium ion may be made while pressurizing the electrode plate 10 to the doping rollers 116.

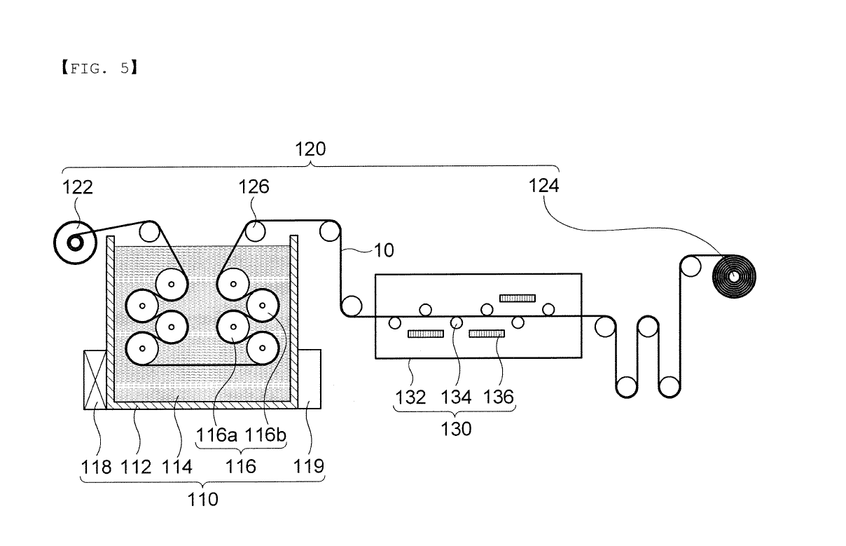

Referring to FIGS. 2 and 5, the electrode plate 10 may be dried (S130). For example, after doping the lithium ion, the electrode plate 10 carried out of the doping chamber body 112 may be in a wetting state by the electrolyte solution 114. Therefore, the process of removing the electrolyte solution 114 remaining in the electrode plate 10 may be performed. To this end, the drying the electrode plate 10 may be made by heating the electrode plate 10 with a predetermined heater or applying hot air by the hot air blower.

The electrode plate 10 subjected to the lithium doping process may be recovered (S140). The recovering the electrode plate 10 may store the drying-processed electrode plate 10 while winding the electrode plate 10 to the second roller 124. Herein, when the electrode plates 10 wound to the first roller 122 are wound to the second roller 124, the second roller 124 may be separated from the doping apparatus 100 and may move to a place where the subsequent processes for manufacturing the electrode are performed.

As described above, the method for manufacturing an electrode according to the exemplary embodiment of the present invention may be made by consecutively processing the steps of standing-by the electrode plate 10, doping the electrode plate 10 with lithium ion, drying the electrode plate 10, and recovering the electrode plate 10 in an in-situ manner. Therefore, the method for manufacturing an electrode according to the exemplary embodiment of the present invention automatically processes the electrode plate stand-by process, the lithium ion doping process, the electrode plate drying process, and the electrode plate recovering process in the in-line manner in a single doping apparatus, thereby making it possible to shorten the electrode manufacturing process time of the energy storage device and improve the production.

The doping apparatus for manufacturing an electrode of an energy storage device according to the present invention includes a doping chamber having an inner space in which the doping plates are stacked and an electrode plate feeder moving the electrode plate to sequentially pass through gaps between the doping plates, wherein the doping chamber and the electrode plate feeder may include a structure of capable of maximizing the moving distance and the doping time of the electrode plate passing through the gaps. Therefore, the lithium doping apparatus according to the present invention increases the doping section between the electrode plate and the doping plates per unit area, thereby making it possible to improve the efficiency in the lithium doping process.

Further, the doping apparatus according to the present invention can consecutively and automatically process the stand-by process of the electrode plate prior to the doping, the doping process, the dry process, and the recovery process. Therefore, the lithium doping apparatus according to the present invention automates the lithium doping process in an in-line manner, thereby making it possible to improve the efficiency in the lithium doping process and shorten the lithium doping process time.

In addition, the method for manufacturing an electrode according to the exemplary embodiment of the present invention automatically processes the electrode plate stand-by process, the lithium ion doping process, the electrode drying process, and the electrode plate recovering process in the in-line manner in a single doping apparatus, thereby making it possible to shorten the electrode manufacturing process time of the energy storage device and improve the production.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A doping apparatus for manufacturing an electrode of an energy storage device, comprising:
a doping chamber body providing a inner space in which a process doping an electrode plate with lithium ion is performed; and
a plurality of doping rollers provided in the doping chamber body and containing lithium,
wherein the doping rollers wind and feed the electrode plate within the doping chamber body.

2. The doping apparatus for manufacturing an electrode of an energy storage device according to claim 1, wherein the doping rollers include:
first doping rollers contacting one surface of the doping plate; and
second doping rollers contacting the other surface of the doping plate.

3. The doping apparatus for manufacturing an electrode of an energy storage device according to claim 2, further comprising a driver moving the doping rollers,
wherein the driver moves the first doping rollers in a first direction to face the electrode plate and moves the second doping rollers in a direction opposite to the first direction to face the electrode plate.

4. The doping apparatus for manufacturing an electrode of an energy storage device according to claim 1, wherein the doping rollers are disposed at both sides based on a straight line crossing the doping chamber body and the doping rollers disposed at one side of the straight line are disposed to have a zigzag structure with the doping rollers disposed at the other side of the straight line based on the straight line.

5. The doping apparatus for manufacturing an electrode of an energy storage device according to claim 1, further comprising an electrode plate feeder feeding the electrode plate,
wherein the electrode plate feeder includes:
a first roller winding and standing-by the electrode plate prior to the lithium doping process;
a second roller winding and recovering the electrode plate subjected to the lithium doping process and carried out of the doping chamber body; and
third rollers guiding the electrode plate unwound from the first roller into the doping rollers and then, recovering the electrode plate fed by the doping rollers to the second roller.

6. The doping apparatus for manufacturing an electrode of an energy storage device according to claim 1, further comprising a heater heating the electrolyte solution so as to allow a temperature of an electrolyte solution to meet a temperature range of 20° C. to 70° C.

7. The doping apparatus for manufacturing an electrode of an energy storage device according to claim 1, wherein the doping chamber further includes an electrolyte solution filling the inner space, and
the electrolyte solution includes at least one lithium-based electrolytic salt of LiPF6, LiBF4, LiSbF6, LiAsF5, LiClO4, LiN, CF3SO3, LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi.

8. The doping apparatus for manufacturing an electrode of an energy storage device according to claim 1, further comprising a dry chamber drying the electrode plate.

9. The doping apparatus for manufacturing an electrode of an energy storage device according to claim 8, wherein the dry chamber includes:
a dry chamber body;
fourth rollers disposed to have a zigzag structure in the dry chamber body; and
a heater heating the electrode plate moved by the fourth rollers.

10. A method for manufacturing an electrode of an energy storage device, comprising:
standing-by an electrode plate;
doping the electrode plate with lithium ion while feeding the electrode plate, by using doping rollers containing lithium ion; and
recovering the electrode plate,
wherein the standing-by the electrode plate, the doping the electrode plate with the lithium ion, and the recovering the electrode plate are performed in an in-situ manner.

11. The method for manufacturing an electrode of an energy storage device according to claim 10, wherein the standing-by the electrode plate includes preparing a first roller to which the electrode plate is wound prior to performing the lithium doping process, and
the recovering the electrode plate includes winding and recovering the electrode plate to a second roller after performing the lithium doping process.

12. The method for manufacturing an electrode of an energy storage device according to claim 10, wherein the doping the electrode plate with lithium ion includes:
preparing a doping chamber body filled with an electrolyte solution;
disposing the doping rollers in the doping chamber body; and
feeding the electrode plate by rotating the doping rollers in the state where the electrode plate contacts the doping rollers.

13. The method for manufacturing an electrode of an energy storage device according to claim 10, wherein the doping the electrode plate with the lithium ion includes:
preparing first doping rollers contacting one surface of the electrode plate;
preparing second doping rollers contacting the other surface of the electrode plate; and
alternately and repeatedly contacting the first doping rollers and the second doping rollers to one surface and the other surface of the electrode plate.

14. The method for manufacturing an electrode of an energy storage device according to claim 10, wherein the doping the electrode plate with lithium ion includes:
doping one surface of the electrode plate with lithium ion; and
doping the other surface of the electrode plate with lithium ion,
wherein the doping the one surface of the electrode plate with lithium ion and the doping the other surface of the electrode plate with lithium ion are alternately and repeatedly performed.

15. The method for manufacturing an electrode of an energy storage device according to claim 10, wherein the doping the electrode plate with lithium ion includes heating the electrolyte solution so as to allow a temperature of an electrolyte solution to meet a temperature range of 20° C. to 70° C.

16. The method for manufacturing an electrode of an energy storage device according to claim 10, wherein the electrolyte solution includes at least one lithium-based electrolytic salt of LiPF6, LiBF4, LiSbF6, LiAsF5, LiClO4, LiN, CF3SO3, LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi.

17. The method for manufacturing an electrode of an energy storage device according to claim 10, further comprising drying the electrode plate after performing the lithium doping process.

18. The method for manufacturing an electrode of an energy storage device according to claim 10, further comprising closely attaching the doping rollers to the electrode plate.
